(19) United States
(12) Patent Application Publication
(10) Pub. No.: US 2026/0301687 A1
(43) Pub. Date: Oct. 1, 2026

(54) ELECTRONIC APPARATUS

(71) Applicant: Samsung Display Co., LTD., Yongin-si (KR)

(72) Inventors: JINJOO HA, Yongin-si (KR); KYUNGHO KIM, Yongin-si (KR); BYUNGCHANG YU, Yongin-si (KR)

(21) Appl. No.: 19/540,322

(22) Filed: Feb. 13, 2026

(30) Foreign Application Priority Data
Mar. 25, 2025 (KR) 10-2025-0037916

(51) Int. Cl. G09G 3/3266

(52) U.S. Cl. CPC G09G 3/3266; G09G 2310/0286

(57) ABSTRACT

A gate driver of an electronic apparatus includes an input circuit which transmits a previous carry signal to CQ node in response to the previous carry signal, a first buffer circuit which outputs a first clock signal as a first gate output signal in response to a signal of Q1 node, a second buffer circuit which outputs a second clock signal as a second gate output signal in response to a signal of Q2 node, a first pull down holding circuit which holds a low level of the first gate output signal in response to a signal of QB1 node and a second pull down holding circuit which holds a low level of the second gate output signal in response to the signal of the QB1 node. The input circuit is in a first layer. The first buffer layer and the second buffer layer are in a second layer.

This application claims priority to Korean Patent Application No. 10-2025-0037916, filed on Mar. 25, 2025, and all the benefits accruing therefrom under 35 U.S.C. § 119, the content of which in its entirety is herein incorporated by reference.

### BACKGROUND

### 1. Field

Embodiments of the invention relate to an electronic apparatus. More particularly, embodiments of the invention relate to an electronic apparatus including a gate driver for reducing a dead space of a display apparatus.

### 2. Description of the Related Art

Generally, a display apparatus (or an electronic apparatus that displays an image) includes a display panel and a display panel driver. The display panel includes a plurality of gate lines, a plurality of data lines, a plurality of emission lines and a plurality of pixels. The display panel driver may include a gate driver, a data driver, an emission driver and a driving controller. The gate driver outputs gate signals to the gate lines. The data driver outputs data voltages to the data lines. The emission driver outputs emission signals to the emission lines. The driving controller controls the gate driver, the data driver and the emission driver.

In a case where the gate driver is integrated on the display panel, a dead space of the display apparatus may be increased by a circuit of the gate driver.

### SUMMARY

Embodiments of the invention provide an electronic apparatus including a gate driver including a first circuit disposed in a first layer and a second circuit disposed in a second layer overlapping the first layer to reduce a dead space of a display apparatus.

In an embodiment of an electronic apparatus according to the invention, the electronic apparatus includes a gate driver, a driving controller which controls the gate driver and a processor which outputs input image data and an input control signal to the driving controller. In such an embodiment, The gate driver includes an input circuit which transmits a previous carry signal to a CQ node in response to the previous carry signal, a first buffer circuit which outputs a first clock signal as a first gate output signal in response to a signal of a Q1 node, a second buffer circuit which outputs a second clock signal as a second gate output signal in response to a signal of a Q2 node, a first pull down holding circuit which holds a low level of the first gate output signal in response to a signal of a QB1 node and a second pull down holding circuit which holds a low level of the second gate output signal in response to the signal of the QB1 node. In such an embodiment, the input circuit is disposed in a first layer. In such an embodiment, the first buffer layer and the second buffer layer are disposed in a second layer overlapping the first layer.

In an embodiment, the gate driver may further include a first CQ node control circuit which applies a first low power voltage or a second low power voltage to the CQ node in response to a next carry signal.

In an embodiment, the gate driver may further include a second CQ node control circuit which applies a second low power voltage to the CQ node in response to the signal of the QB1 node.

In an embodiment, gate driver may further include an inverting circuit which controls the signal of the QB1 node in response to a first inverting control signal and a signal of the CQ node.

In an embodiment, the gate driver may further include a carry buffer circuit which outputs a first carry clock signal as a carry signal in response to a signal of a CRQ node.

In an embodiment, the gate driver may further include a carry pull down holding circuit which holds a low level of the carry signal in response to the signal of the QB1 node.

In an embodiment, the gate driver may further include a carry node separating circuit connected to a carry output terminal and the CQ node.

In an embodiment, the gate driver may further include a first node separating circuit connected to a first gate output terminal and the CQ node and a second node separating circuit connected to a second gate output terminal and the CQ node.

In an embodiment, a control signal of the first node separating circuit may be an initialization gate signal different from the first gate output signal and the second gate output signal. In such an embodiment, a control signal of the second node separating circuit may be the initialization gate signal. In such an embodiment, a high period of the initialization gate signal may overlap a high period of the first gate output signal and a high period of the second gate output signal.

In an embodiment, a control signal of the first node separating circuit may be a second high power voltage. In such an embodiment, Aa control signal of the second node separating circuit may be the second high power voltage.

In an embodiment, a control signal of the first node separating circuit may be a clock signal different from the first clock signal and the second clock signal. In such an embodiment, a control signal of the second node separating circuit may be the clock signal. In such an embodiment, a high period of the clock signal may overlap a high period of the first gate output signal and a high period of the second gate output signal.

In an embodiment, the gate driver may further include a reset circuit which applies a first low power voltage or a second low power voltage to the CQ node in response to a reset signal.

In an embodiment, the gate driver may further include a stabilizing circuit which applies a high power voltage to a third intermediate node connecting a 3-1 transistor and a 3-2 transistor of the input circuit to each other in response to a signal of the CQ node.

In an embodiment, the gate driver may further include a 1-2 pull down holding circuit which holds the low level of the first gate output signal in response to a signal of a QB2 node and a 2-2 pull down holding circuit which holds the low level of the second gate output signal in response to the signal of the QB2 node.

In an embodiment, the gate driver may further include a 2-2 CQ node control circuit which applies a second low power voltage to the CQ node in response to the signal of the QB2 node, a second inverting circuit which controls the signal of the QB2 node in response to a second inverting control circuit and a signal of the CQ node and a second carry pull down holding circuit which holds a low level of the carry signal in response to the signal of the QB2 node.

In an embodiment, the gate driver may further include a third buffer circuit which outputs a third clock signal as a third gate output signal in response to a signal of a Q3 node and a third pull down holding circuit which holds a low level of the third gate output signal in response to the signal of the QB1 node.

In an embodiment, the input circuit may include a 3-1 transistor including a control electrode which receives the previous carry signal, a first electrode which receives the previous carry signal and a second electrode connected to a third intermediate node and a 3-2 transistor including a control electrode which receives the previous carry signal, a first electrode connected to the third intermediate node and a second electrode connected to the CQ node. In such an embodiment, the first buffer circuit may include a 10-1 transistor including a control electrode connected to the Q1 node, a first electrode which receives the first clock signal and a second electrode connected to a first gate output terminal. In such an embodiment, the second buffer circuit may include a 10-2 transistor including a control electrode connected to the Q2 node, a first electrode which receives the second clock signal and a second electrode connected to a second gate output terminal. In such an embodiment, the first pull down holding circuit may include an 11-1 transistor including a control electrode connected to the QB1 node, a first electrode which receives a first low power voltage and a second electrode connected to the first gate output terminal. In such an embodiment, the second pull down holding circuit may include an 11-2 transistor including a control electrode connected to the QB1 node, a first electrode which receives the first low power voltage and a second electrode connected to the second gate output terminal.

In an embodiment, the gate driver may further include a 1-1 transistor including a control electrode connected to the CQ node, a first electrode which receives a high power voltage and a second electrode connected to a first intermediate node, a 1-2 transistor including a control electrode connected to the CQ node, a first electrode connected to the first intermediate node and a second electrode connected to the third intermediate node, a 2-1 transistor including a control electrode which receives a reset signal, a first electrode connected to the CQ node and a second electrode connected to a second intermediate node, a 2-2 transistor including a control electrode which receives the reset signal, a first electrode which receives a second low power voltage and a second electrode connected to the second intermediate node, a 4-1 transistor including a control electrode which receives a next carry signal, a first electrode connected to the CQ node and a second electrode connected to a fourth intermediate node, a 4-2 transistor including a control electrode which receives the next carry signal, a first electrode which receives the second low power voltage and a second electrode connected to the fourth intermediate node, a 5-1 transistor connected to the QB1 node, a first electrode connected to the CQ node and a second electrode connected to a fifth intermediate node, a 5-2 transistor including a control electrode connected to the QB1 node, a first electrode which receives the second low power voltage and a second electrode connected to the fifth intermediate node, a 6-1 transistor including a control electrode connected to a QB2 node, a first electrode connected to the CQ node and a second electrode connected to a sixth intermediate node, a 6-2 transistor including a control electrode connected to the QB2 node, a first electrode which receives the second low power voltage and a second electrode connected to the sixth intermediate node, a seventh transistor including a control electrode connected to a CRQ node, a first electrode which receives a first carry clock signal and a second electrode connected to a carry output terminal, an eighth transistor including a control electrode connected to the QB1 node, a first electrode which receives the second low power voltage and a second electrode connected to the carry output terminal, a ninth transistor including a control electrode connected to the QB2 node, a first electrode which receives the second low power voltage and a second electrode connected to the carry output terminal, a 12-1 transistor including a control electrode connected to the QB2 node, a first electrode which receives the first low power voltage and a second electrode connected to the first gate output terminal, a 12-2 transistor including a control electrode connected to the QB2 node, a first electrode which receives the first low power voltage and a second electrode connected to the second gate output terminal, a 13-1 transistor including a control electrode which receives a first inverting control signal, a first electrode connected to a first inverting control node and a second electrode connected to a thirteenth intermediate node, a 13-2 transistor including a control electrode which receives the first inverting control signal, a first electrode which receives the first inverting control signal and a second electrode connected to the thirteenth intermediate node, a fourteenth transistor including a control electrode connected to the first inverting control node, a first electrode which receives the first inverting control signal and a second electrode connected to the QB1 node, a fifteenth transistor including a control electrode connected to the CQ node, a first electrode which receives the first low power voltage and a second electrode connected to the first inverting control node, a sixteenth transistor including a control electrode connected to the CQ node, a first electrode which receives the second low power voltage and a second electrode connected to the QB1 node, a 17-1 transistor including a control electrode which receives a second inverting control signal, a first electrode connected to a second inverting control node and a second electrode connected to a seventeenth intermediate node, a 17-2 transistor including a control electrode which receives the second inverting control signal, a first electrode which receives the second inverting control signal and a second electrode connected to the seventeenth intermediate node, an eighteenth transistor including a control electrode connected to the second inverting control node, a first electrode which receives the second inverting control signal and a second electrode connected to the QB2 node, a nineteenth transistor including a control electrode connected to the CQ node, a first electrode which receives the first low power voltage and a second electrode connected to the second inverting control node, a twentieth transistor including a control electrode connected to the CQ node, a first electrode which receives the second low power voltage and a second electrode connected to the QB2 node, a twenty first transistor including a control electrode which receives a node separating control signal, a first electrode connected to the CQ node and a second electrode connected to the CRQ node, a 22-1 transistor including a control electrode which receives the node separating control signal, a first electrode connected to the CQ node and a second electrode connected to the Q1 node and a 22-2 transistor including a control electrode which receives the node separating control signal, a first electrode connected to the CQ node and a second electrode connected to the Q2 node. In such an embodiment, the second intermediate node, the third intermediate node, the fourth intermediate node, the fifth intermediate node and the sixth intermediate node may be connected to one another.

In an embodiment, the gate driver may further include a first capacitor including a first electrode connected to the CRQ node and a second electrode connected to the carry output terminal, a second capacitor including a first electrode connected to the first inverting control node and a second electrode connected to the QB1 node, a third capacitor including a first electrode connected to the second inverting control node and a second electrode connected to the QB2 node, a 4-1 capacitor including a first electrode connected to the Q1 node and a second electrode connected to the first gate output terminal and a 4-2 capacitor including a first electrode connected to the Q2 node and a second electrode connected to the second gate output terminal.

In an embodiment, the 1-1 transistor, the 1-2 transistor, the 2-1 transistor, the 2-2 transistor, the 3-1 transistor, the 3-2 transistor, the 4-1 transistor, the 4-2 transistor, the 5-1 transistor, the 5-2 transistor, the 6-1 transistor, the 6-2 transistor, the seventh transistor, the eighth transistor, the ninth transistor, the 11-1 transistor, the 11-2 transistor, the 12-1 transistor, the 12-2 transistor, the 13-1 transistor, the 13-2 transistor, the fourteenth transistor, the fifteenth transistor, the sixteenth transistor, the 17-1 transistor, the 17-2 transistor, the eighteenth transistor, the nineteenth transistor, the twentieth transistor, the twenty first transistor, the 22-1 transistor, the 22-2 transistor, the first capacitor, the second capacitor and the third capacitor may be disposed in the first layer. In such an embodiment, the 10-1 transistor, the 10-2 transistor, the 4-1 capacitor and the 4-2 capacitor may be disposed in the second layer.

According to an embodiment of the electronic apparatus including the gate driver, all of the transistors included in the gate driver may be N-type transistors.

In such an embodiment where all of the transistors of the display panel are N-type transistors to effectively prevent a current leakage and the gate driver is integrated on the display panel, all of the transistors included in the gate driver may be N-type transistors. Accordingly, the manufacturing process may be simplified and the current leakage in the gate driver may be substantially reduced or effectively prevented. In such an embodiment, the flicker due to the current leakage may be substantially reduced or effectively prevented so that the display quality of the display panel may be enhanced.

In an embodiment, the first circuit of the gate driver may be disposed in the first layer and the second circuit of the gate driver may be disposed in the second layer overlapping the first layer so that the dead space of the display apparatus may be reduced.

In an embodiment, the plurality of the buffer circuits of the gate driver may share a single pull up control node of the gate driver so that the dead space of the display apparatus may be further reduced.

In an embodiment, the common Q node may be precharged or discharged not based on the clock signal but based on the previous carry signal and the next carry signal so that the power consumption of the gate driver may be reduced and the ripple due to the clock signal may be effectively prevented.

In an embodiment, the inverting circuit, the pull down holding circuit, the carry pull down holding circuit and the QB node may be formed in a dual configuration so that the deteriorations of the inverting circuit, the pull down holding circuit, the carry pull down holding circuit and the QB node may be effectively prevented.

### BRIEF DESCRIPTION OF THE DRAWINGS

The above and other features of embodiments of the invention will become more apparent by describing in detail embodiments thereof with reference to the accompanying drawings, in which:

FIG. 1 is a block diagram illustrating a display apparatus according to an embodiment of the invention;

FIG. 2 is a block diagram illustrating a gate driver of FIG. 1;

FIG. 3 is a circuit diagram illustrating the gate driver of FIG. 1;

FIG. 4 is a timing diagram illustrating input signals, node signals and output signals of the gate driver of FIG. 3;

FIG. 5 is a circuit diagram illustrating a first circuit of the gate driver of FIG. 3 disposed in a first layer;

FIG. 6 is a circuit diagram illustrating a second circuit of the gate driver of FIG. 3 disposed in a second layer;

FIG. 7 is a circuit diagram illustrating a gate driver of a display apparatus according to an embodiment of the invention;

FIG. 8 is a circuit diagram illustrating a gate driver of a display apparatus according to an embodiment of the invention;

FIG. 9 is a circuit diagram illustrating a gate driver of a display apparatus according to an embodiment of the invention;

FIG. 10 is a block diagram illustrating an electronic apparatus according to an embodiment of the invention;

FIG. 11 is a diagram illustrating an example in which the electronic apparatus of FIG. 10 is implemented as a smart phone;

FIG. 12 is a diagram illustrating an example in which the electronic apparatus of FIG. 10 is implemented as a monitor; and

FIG. 13 is a diagram illustrating an example in which the electronic apparatus of FIG. 10 is implemented as a tablet PC.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third”, “1-1”, “1-2”, “2-1”, “2-2” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, “a”, “an,” “the,” and “at least one” do not denote a limitation of quantity, and are intended to include both the singular and plural, unless the context clearly indicates otherwise. Thus, reference to “an” element in a claim followed by reference to “the” element is inclusive of one element and a plurality of the elements. For example, “an element” has the same meaning as “at least one element,” unless the context clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The terms “below” or “beneath” can, therefore, encompass both an orientation of above and below.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Hereinafter, embodiments of the invention will be described in detail with reference to the accompanying drawings.

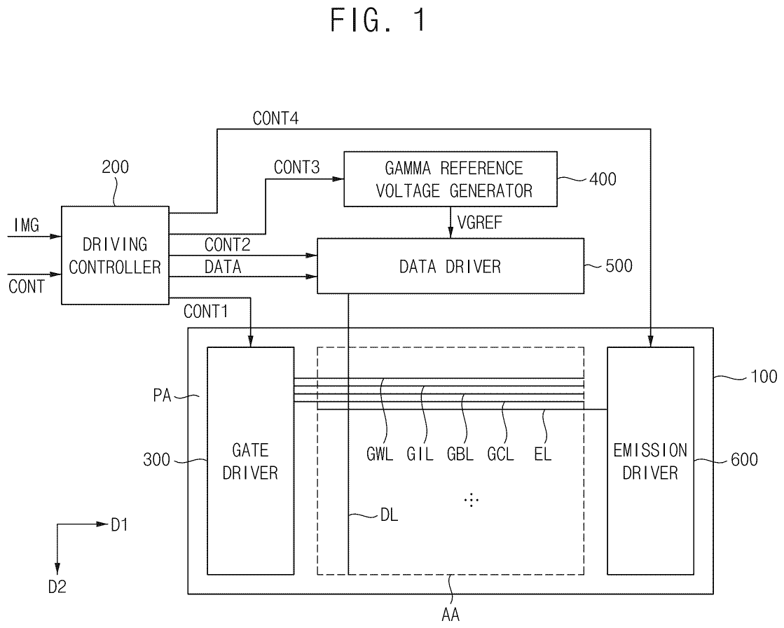

FIG. 1 is a block diagram illustrating a display apparatus according to an embodiment of the invention.

Referring to FIG. 1, an embodiment of the display apparatus includes a display panel 100 and a display panel driver. The display panel driver includes a driving controller 200, a gate driver 300, a gamma reference voltage generator 400, a data driver 500 and an emission driver 600.

The display panel 100 has a display region AA, on which an image is displayed, and a peripheral region PA adjacent to the display region AA.

The display panel 100 may include a plurality of gate lines GWL, GIL, GBL and GCL, a plurality of data lines DL, a plurality of emission lines EL and a plurality of pixels electrically connected to the gate lines GWL, GIL, GBL and GCL, the data lines DL and the emission lines EL. The gate lines GWL, GIL, GBL and GCL may extend in a first direction D1, the data lines DL may extend in a second direction D2 crossing the first direction D1 and the emission lines EL may extend in the first direction D1.

The driving controller 200 may receive input image data IMG and an input control signal CONT from an external apparatus. In an embodiment, for example, the input image data IMG may include red image data, green image data and blue image data. The input image data IMG may include white image data. In another embodiment, for example, the input image data IMG may include magenta image data, cyan image data and yellow image data. The input control signal CONT may include a master clock signal and a data enable signal. The input control signal CONT may further include a vertical synchronizing signal and a horizontal synchronizing signal.

The driving controller 200 generates a first control signal CONT1, a second control signal CONT2, a third control signal CONT3, a fourth control signal CONT4 and a data signal DATA based on the input image data IMG and the input control signal CONT.

The driving controller 200 generates the first control signal CONT1 for controlling an operation of the gate driver 300 based on the input control signal CONT, and outputs the first control signal CONT1 to the gate driver 300. The first control signal CONT1 may include a vertical start signal and a gate clock signal.

The driving controller 200 generates the second control signal CONT2 for controlling an operation of the data driver 500 based on the input control signal CONT, and outputs the second control signal CONT2 to the data driver 500. The second control signal CONT2 may include a horizontal start signal and a load signal.

The driving controller 200 generates the data signal DATA based on the input image data IMG. The driving controller 200 outputs the data signal DATA to the data driver 500.

The driving controller 200 generates the third control signal CONT3 for controlling an operation of the gamma reference voltage generator 400 based on the input control signal CONT, and outputs the third control signal CONT3 to the gamma reference voltage generator 400.

The driving controller 200 generates the fourth control signal CONT4 for controlling an operation of the emission driver 600 based on the input control signal CONT, and outputs the fourth control signal CONT4 to the emission driver 600.

The gate driver 300 generates gate signals driving the gate lines GWL, GIL, GBL and GCL in response to the first control signal CONT1 received from the driving controller 200. The gate driver 300 may output the gate signals to the gate lines GWL, GIL, GBL and GCL. In an embodiment, for example, the gate driver 300 may be integrated on the peripheral region PA of the display panel 100. In an embodiment, for example, the gate driver 300 may be mounted on the peripheral region PA of the display panel 100.

The gamma reference voltage generator 400 generates a gamma reference voltage VGREF in response to the third control signal CONT3 received from the driving controller 200. The gamma reference voltage generator 400 provides the gamma reference voltage VGREF to the data driver 500. The gamma reference voltage VGREF is used for converting the data signal DATA into the data voltage having an analog type.

In an embodiment, the gamma reference voltage generator 400 may be disposed in the driving controller 200, or in the data driver 500.

The data driver 500 receives the second control signal CONT2 and the data signal DATA from the driving controller 200, and receives the gamma reference voltages VGREF from the gamma reference voltage generator 400. The data driver 500 converts the data signals DATA into the data voltages having an analog type using the gamma reference voltages VGREF. The data driver 500 outputs the data voltages to the data lines DL.

The emission driver 600 generates emission signals to drive the emission lines EL in response to the fourth control signal CONT4 received from the driving controller 200. The emission driver 600 may output the emission signals to the emission lines EL. In an embodiment, for example, the emission driver 600 may be integrated on the peripheral region PA of the display panel 100. In an embodiment, for example, the emission driver 600 may be mounted on the peripheral region PA of the display panel 100.

Although an embodiment where the gate driver 300 is disposed at a first side of the display panel 100 and the emission driver 600 is disposed at a second side of the display panel 100 opposite to the first side is shown in FIG. 1 for convenience of illustration and description, the invention may not be limited thereto. In another embodiment, for example, both of the gate driver 300 and the emission driver 600 may be disposed at the first side of the display panel 100. In another embodiment, for example, both of the gate driver 300 and the emission driver 600 may be disposed at both opposing sides of the display panel 100. In an embodiment, for example, the gate driver 300 and the emission driver 600 may be integrally formed.

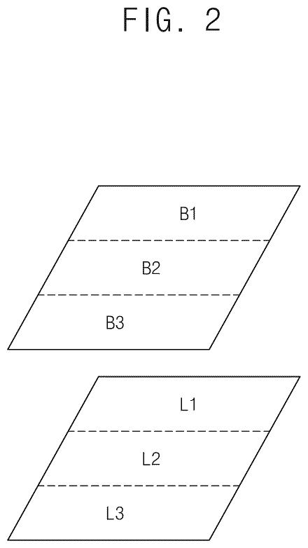

FIG. 2 is a block diagram illustrating the gate driver 300 of FIG. 1.

Referring to FIGS. 1 and 2, an embodiment of the gate driver 300 may include a first circuit L1, L2 and L3 disposed in a first layer and a second circuit B1, B2 and B3 disposed in a second layer overlapping the first layer.

In an embodiment, for example, the first circuit L1, L2 and L3 may include a first logic circuit L1, a second logic circuit L2 and a third logic circuit L3. The second circuit B1, B2 and B3 may include a first buffer circuit B1, a second buffer circuit B2 and a third buffer circuit B3.

In an embodiment, for example, the first buffer circuit B1 may include a buffer transistor that outputs a first gate signal to a first gate line. In an embodiment, for example, the second buffer circuit B2 may include a buffer transistor that outputs a second gate signal to a second gate line. In an embodiment, for example, the third buffer circuit B3 may include a buffer transistor that outputs a third gate signal to a third gate line.

In an embodiment, for example, the first logic circuit L1 may include a plurality of transistors for controlling the first buffer circuit B1. In an embodiment, for example, the second logic circuit L2 may include a plurality of transistors for controlling the second buffer circuit B2. In an embodiment, for example, the third logic circuit L3 may include a plurality of transistors for controlling the third buffer circuit B3.

The gate driver 300 may include the first circuit L1, L2 and L3 disposed in the first layer and the second circuit B1, B2 and B3 disposed in the second layer overlapping the first layer so that the dead space of the display apparatus may be reduced.

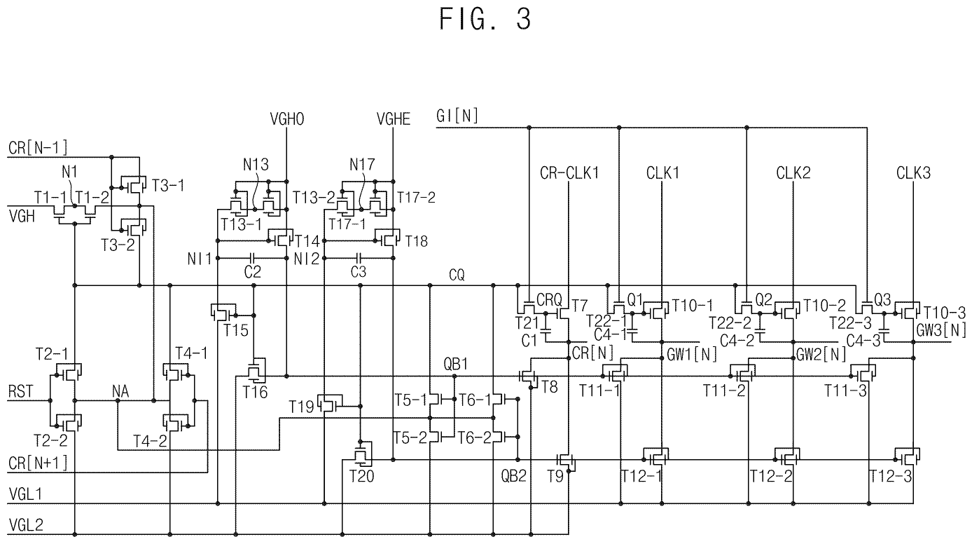

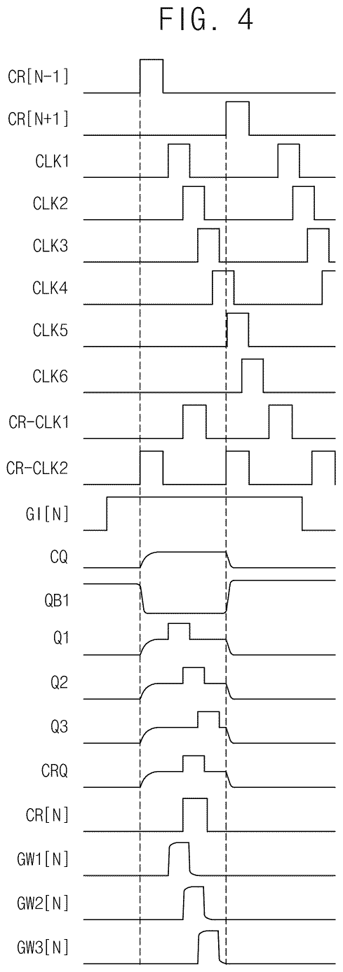

FIG. 3 is a circuit diagram illustrating the gate driver 300 of FIG. 1. FIG. 4 is a timing diagram illustrating input signals, node signals and output signals of the gate driver 300 of FIG. 3.

Referring to FIGS. 1 to 4, an embodiment of the gate driver 300 includes an input circuit that transmits a previous carry signal CR[N−1] to a CQ node in response to the previous carry signal CR[N−1], a first buffer circuit that outputs a first clock signal CLK1 as a first gate output signal GW1[N] in response to a signal of a Q1 node, a second buffer circuit that outputs a second clock signal CLK2 as a second gate output signal GW2[N] in response to a signal of a Q2 node, a first pull down holding circuit that holds a low level of the first gate output signal GW1[N] in response to a signal of a QB1 node and a second pull down holding circuit that holds a low level of the second gate output signal GW2[N] in response to the signal of the QB1 node. In an embodiment, the gate driver 300 may include a plurality of stages, and FIG. 3 may show a circuit diagram of one stages among the plurality of stages. In such an embodiment, the plurality of stages may have a same circuit structure as each other.

Herein, the previous carry signal CR[N−1] is not limited to a carry signal of an immediate previous stage. The previous carry signal CR[N−1] may be one of carry signals of previous stages preceding a present stage.

In such an embodiment, the input circuit is disposed in the first layer, and the first buffer circuit and the second buffer circuit are disposed in the second layer overlapping the first layer.

A structure in which some circuits of the gate driver 300 are disposed in the first layer and other circuits of the gate driver 300 are disposed in the second layer overlapping the first layer may be referred to as a stacked structure. The input circuit of the gate driver 300 is disposed in the first layer and the first buffer circuit and the second buffer circuit of the gate driver 300 are disposed in the second layer overlapping the first layer so that the gate driver 300 may have the stacked structure.

In an embodiment, as described above, the gate driver 300 has the stacked structure so that an integration level may be enhanced and a dead space may be reduced. In such an embodiment, the first buffer circuit and the second buffer circuit may share the CQ node so that the integration level may be further enhanced and the dead space may be further reduced.

In an embodiment, the three buffer circuits may share the CQ node as shown in FIGS. 3 and 4, the invention may not be limited thereto. At least two buffer circuits may share the CQ node in an embodiment of the invention.

Although not shown, in an embodiment where the three buffer circuits share the CQ node, clock signals for outputting gate output signals GW1[N], GW2[N] and GW3[N] may be first to sixth clock signals CLK1 to CLK6 and carry clock signals for outputting a carry signal CR[N] may be a first carry clock signal CR-CLK1 and a second carry clock signal. In such an embodiment, the number of clock signals may not be increased compared to a circuit of a conventional gate driver so that the dead space of the display apparatus may be effectively reduced without increasing the number of clock signals.

The input circuit may include a 3-1 transistor T3-1 including a control electrode that receives the previous carry signal CR[N−1], a first electrode that receives the previous carry signal CR[N−1] and a second electrode connected to a third intermediate node NA, and a 3-2 transistor T3-2 including a control electrode that receives the previous carry signal CR[N−1], a first electrode connected to the third intermediate node NA and a second electrode connected to the CQ node.

The input circuit may precharge the CQ node in response to the previous carry signal CR[N−1]. The input circuit may operate in response not to the clock signal but to the previous carry signal CR[N−1] so that a ripple generated due to a swing of the clock signal may be effectively prevented.

The first buffer circuit may include a 10-1 transistor T10-1 including a control electrode connected to the Q1 node, a first electrode that receives the first clock signal CLK1 and a second electrode connected to a first gate output terminal.

The second buffer circuit may include a 10-2 transistor T10-2 including a control electrode connected to the Q2 node, a first electrode that receives the second clock signal CLK2 and a second electrode connected to a second gate output terminal.

The gate driver 300 may further include a first node separating circuit connected to a first gate output terminal and the CQ node and a second node separating circuit connected to a second gate output terminal and the CQ node.

In such an embodiment, a control signal of the first node separating circuit may be an initialization gate signal GI[N] different from the first gate output signal GW1[N] and the second gate output signal GW2[N]. A control signal of the second node separating circuit may be the initialization gate signal GI[N]. A high period of the initialization gate signal GI[N] may overlap a high period of the first gate output circuit GW1[N] and a high period of the second gate output circuit GW2[N].

A signal having a high level at an output timing of the first gate output signal GW1[N] and an output timing of the first gate output signal GW2[N] may be used as a node separating control signal (e.g., GI[N]) which is a control signal of the first node separating circuit and the second node separating circuit. In such an embodiment, one (e.g., GI[N]) of gate signals applied to a pixel is used as the node separating control signal so that a structure for generating the node separating control signal may be omitted and a separate power voltage may not be generated, and accordingly, a circuit structure of the display apparatus may be simplified.

The first node separating circuit may include a 22-1 transistor T22-1 including a control electrode that receives the node separating control signal GI[N], a first electrode connected to the CQ node and a second electrode connected to the Q1 node. A bootstrap voltage of the Q1 node may not be transmitted to the CQ node by the first node separating circuit so that the 10-1 transistor T10-1 may output the first gate output signal GW1[N] more stably. In addition, a horizontal line defect, which may occur when the bootstrap voltage of the Q1 node is transmitted to the CQ node, may be effectively prevented.

The second node separating circuit may include a 22-2 transistor T22-2 including a control electrode that receives the node separating control signal GI[N], a first electrode connected to the CQ node and a second electrode connected to the Q2 node. A bootstrap voltage of the Q2 node may not be transmitted to the CQ node by the second node separating circuit so that the 10-2 transistor T10-2 may output the second gate output signal GW2[N] more stably. In addition, a horizontal line defect which may occur, when the bootstrap voltage of the Q2 node is transmitted to the CQ node, may be effectively prevented.

The first pull down holding circuit may include an 11-1 transistor T11-1 including a control electrode connected to the QB1 node, a first electrode that receives a first low power voltage VGL1 and a second electrode connected to the first gate output terminal.

The second pull down holding circuit may include an 11-2 transistor T11-2 including a control electrode connected to the QB1 node, a first electrode that receives the first low power voltage VGL1 and a second electrode connected to the second gate output terminal.

The gate driver 300 may further include a first CQ node control circuit that applies the first low power voltage VGL1 or a second low power voltage VGL2 to the CQ node in response to a next carry signal CR[N+1]. The first CQ node control circuit may discharge the CQ node in response to the next carry signal CR[N+1].

Herein, the next carry signal CR[N+1] is not limited to a carry signal of an immediate next stage. The next carry signal CR[N+1] may be one of carry signals of next stages following the present stage.

In such an embodiment, the first CQ node control circuit may apply the second low power voltage VGL2 to the CQ node in response to the next carry signal CR[N+1].

In an embodiment, for example, the second low power voltage VGL2 may be less than the first low power voltage VGL1, that is, the voltage level of the second low power voltage VGL2 may be lower than the voltage level of the first low power voltage VGL1.

The first CQ node control circuit may include a 4-1 transistor T4-1 including a control electrode that receives the next carry signal CR[N+1], a first electrode connected to the CQ node and a second electrode connected to a fourth intermediate node NA and a 4-2 transistor T4-2 including a control electrode that receives the next carry signal CR[N+1], a first electrode that receives the second low power voltage VGL2 and a second electrode connected to the fourth intermediate node NA.

The gate driver 300 may further include a second CQ node control circuit that applies the second low power voltage VGL2 to the CQ node in response to the signal of the QB1 node. When the signal of the QB1 node has a high level, the second CQ node control circuit may output the second low power voltage VGL2 to the CQ node.

The second CQ node control circuit may include a 5-1 transistor T5-1 connected to the QB1 node, a first electrode connected to the CQ node and a second electrode connected to a fifth intermediate node NA and a 5-2 transistor T5-2 including a control electrode connected to the QB1 node, a first electrode that receives the second low power voltage VGL2 and a second electrode connected to the fifth intermediate node NA.

The gate driver 300 may further include an inverting circuit that controls the signal of the QB1 node in response to a first inverting control signal VGHO and a signal of the CQ node.

The inverting circuit may include a 13-1 transistor T13-1 including a control electrode that receives the first inverting control signal VGHO, a first electrode connected to a first inverting control node NI1 and a second electrode connected to a thirteenth intermediate node N13, a 13-2 transistor T13-2 including a control electrode that receives the first inverting control signal VGHO, a first electrode that receives the first inverting control signal VGHO and a second electrode connected to the thirteenth intermediate node N13, a fourteenth transistor T14 including a control electrode connected to the first inverting control node NI1, a first electrode that receives the first inverting control signal VGHO and a second electrode connected to the QB1 node, a fifteenth transistor T15 including a control electrode connected to the CQ node, a first electrode that receives the first low power voltage VGL1 and a second electrode connected to the first inverting control node NI1, and a sixteenth transistor T16 including a control electrode connected to the CQ node, a first electrode that receives the second low power voltage VGL2 and a second electrode connected to the QB1 node.

When the signal of the CQ node has a high level, the fifteenth transistor T15 and the sixteenth transistor T16 of the inverting circuit may be turned on so that the second low power voltage VGL2 may be applied to the QB1 node.

When the signal of the CQ node has a low level, the 13-1 transistor T13-1, the 13-2 transistor T13-2 and the fourteenth transistor T14 of the inverting circuit may be turned on so that the first inverting control signal VGHO may be applied to the QB1 node. The first inverting control signal VGHO may have a high level.

The gate driver 300 may further include a carry buffer circuit that outputs the first carry clock signal CR-CLK1 as a carry signal CR[N] in response to a signal of a CRQ node.

The carry buffer circuit may include a seventh transistor T7 including a control electrode connected to the CRQ node, a first electrode that receives the first carry clock signal CR-CLK1 and a second electrode connected to a carry output terminal, through which the carry signal CR[N] is output.

The gate driver 300 may further include a carry pull down holding circuit that holds a low level of the carry signal CR[N] in response to the signal of the QB1 node.

The carry pull down holding circuit may include an eighth transistor T8 including a control electrode connected to the QB1 node, a first electrode that receives the second low power voltage VGL2 and a second electrode connected to the carry output terminal.

The gate driver 300 may further include a carry node separating circuit connected to the carry output terminal and the CQ node.

The carry node separating circuit may include a twenty first transistor T21 including a control electrode that receives the node separating control signal GI[N], a first electrode connected to the CQ node and a second electrode connected to the CRQ node. A bootstrap voltage of the CRQ node may not be transmitted to the CQ node by the carry node separating circuit so that the seventh transistor T7 may output the carry signal CR[N] more stably. In addition, a horizontal line defect, which may occur when the bootstrap voltage of the CRQ node is transmitted to the CQ node, may be effectively prevented.

The gate driver 300 may further include a reset circuit that applies the first low power voltage VGL1 or the second low power voltage VGL2 to the CQ node in response to a reset signal RST.

In such an embodiment, the reset circuit may apply the second low power voltage VGL2 to the CQ node in response to the reset signal RST.

The reset signal RST may have an active level in an initial turn-on period when the display apparatus is started to be turned on. The display panel 100 may not unintentionally emit a light in the initial turn-on period by the reset signal RST.

The reset circuit may include a 2-1 transistor T2-1 including a control electrode that receives the reset signal RST, a first electrode connected to the CQ node and a second electrode connected to a second intermediate node NA and a 2-2 transistor T2-2 including a control electrode that receives the reset signal RST, a first electrode that receives the second low power voltage VGL2 and a second electrode connected to the second intermediate node NA.

The gate driver 300 may further include a stabilizing circuit that applies a high power voltage VGH to the third intermediate node NA connecting the 3-1 transistor and the 3-2 transistor of the input circuit to each other in response to the signal of the CQ node.

The stabilizing circuit may include a 1-1 transistor T1-1 including a control electrode connected to the CQ node, a first electrode that receives the high power voltage VGH and a second electrode connected to a first intermediate node N1 and a 1-2 transistor T1-2 including a control electrode connected to the CQ node, a first electrode connected to the first intermediate node N1 and a second electrode connected to the third intermediate node NA.

The second intermediate node NA, the third intermediate node NA, the fourth intermediate node NA, the fifth intermediate node NA and a sixth intermediate node NA may be connected to one another, and thus, labeled with a same reference character. When the signal of the CQ node has a high level, the stabilizing circuit may apply the high power voltage VGH to the second intermediate node NA, the third intermediate node NA, the fourth intermediate node NA, the fifth intermediate node NA and the sixth intermediate node NA so that an operation of the gate driver 300 may be stabilized.

In an embodiment, for example, the first gate output signal GW1[N] and the second gate output signal GW2[N] may have a low level for almost entire time of a frame. Thus, the inverting circuit, the pull down holding circuit, the carry pull down holding circuit and the QB node for maintaining the low level of the first gate output signal GW1[N] and the low level of the second gate output signal GW2[N] may be vulnerable to deterioration.

Thus, the inverting circuit, the pull down holding circuit, the carry pull down holding circuit and the QB node may be formed in a dual configuration.

In an embodiment, for example, the gate driver 300 may further include a 1-2 pull down holding circuit that holds the low level of the first gate output signal GW1[N] in response to a signal of a QB2 node and a 2-2 pull down holding circuit that holds the low level of the second gate output signal GW2[N] in response to the signal of the QB2 node.

In addition, the gate driver 300 may further include a 2-2 CQ node control circuit that applies the second low power voltage VGL2 to the CQ node in response to the signal of the QB2 node, a second inverting circuit that controls the signal of the QB2 node in response to a second inverting control signal VGHE and a signal of the CQ node and a second carry pull down holding circuit that holds the low level of the carry signal CR[N] in response to the signal of the QB2 node.

The 1-2 pull down holding circuit may include a 12-1 transistor T12-1 including a control electrode connected to the QB2 node, a first electrode that receives the first low power voltage VGL1 and a second electrode connected to the first gate output terminal.

The 2-2 pull down holding circuit may include a 12-2 transistor T12-2 including a control electrode connected to the QB2 node, a first electrode that receives the first low power voltage VGL1 and a second electrode connected to the second gate output terminal.

The second CQ node control circuit may include a 6-1 transistor T6-1 including a control electrode connected to the QB2 node, a first electrode connected to the CQ node and a second electrode connected to the sixth intermediate node NA and a 6-2 transistor T6-2 including a control electrode connected to the QB2 node, a first electrode that receives the second low power voltage VGL2 and a second electrode connected to the sixth intermediate node NA.

The second inverting circuit may include a 17-1 transistor T17-1 including a control electrode that receives the second inverting control signal VGHE, a first electrode connected to a second inverting control node NI2 and a second electrode connected to a seventeenth intermediate node N17, a 17-2 transistor T17-2 including a control electrode that receives the second inverting control signal VGHE, a first electrode that receives the second inverting control signal VGHE and a second electrode connected to the seventeenth intermediate node N17, an eighteenth transistor T18 including a control electrode connected to the second inverting control node NI2, a first electrode that receives the second inverting control signal VGHE and a second electrode connected to the QB2 node, a nineteenth transistor T19 including a control electrode connected to the CQ node, a first electrode that receives the first low power voltage VGL1 and a second electrode connected to the second inverting control node NI2, and a twentieth transistor T20 including a control electrode connected to the CQ node, a first electrode that receives the second low power voltage VGL2 and a second electrode connected to the QB2 node.

An operation of the second inverting circuit may be substantially the same as an operation of the inverting circuit described above.

The second carry pull down holding circuit may include a ninth transistor T9 including a control electrode connected to the QB2 node, a first electrode that receives the second low power voltage VGL2 and a second electrode connected to the carry output terminal.

In an embodiment, when the first inverting control signal VGHO has a high level and the second inverting control signal VGHE has a low level, the inverting circuit, the second CQ node control circuit, the carry pull down holding circuit, the first pull down holding circuit and the second pull down holding circuit may operate in response to the first inverting control signal VGHO. In such an embodiment, when the first inverting control signal VGHO has the high level and the second inverting control signal VGHE has the low level, the second inverting circuit, the 2-2 CQ node control circuit, the second carry pull down holding circuit, the 1-2 pull down holding circuit and the 2-2 pull down holding circuit may not operate.

In such an embodiment, when the first inverting control signal VGHO has a low level and the second inverting control signal VGHE has a high level, the second inverting circuit, the 2-2 CQ node control circuit, the second carry pull down holding circuit, the 1-2 pull down holding circuit and the 2-2 pull down holding circuit may operate in response to the second inverting control circuit VGHE. In such an embodiment, when the first inverting control signal VGHO has the low level and the second inverting control signal VGHE has the high level, the inverting circuit, the second CQ node control circuit, the carry pull down holding circuit, the first pull down holding circuit and the second pull down holding circuit may not operate.

In an embodiment, as shown in FIG. 4, the inverting circuit, the second CQ node control circuit, the carry pull down holding circuit, the first pull down holding circuit and the second pull down holding circuit may operate in response to the first inverting control signal VGHO, and the second inverting circuit, the 2-2 CQ node control circuit, the second carry pull down holding circuit, the 1-2 pull down holding circuit and the 2-2 pull down holding circuit may not operate.

In an embodiment, for example, the first inverting control signal VGHO and the second inverting control signal VGHE may alternate in a unit of a frame. In an embodiment, for example, when the first inverting control signal VGHO has the high level and the second inverting control signal VGHE has the low level in an N-th frame, the first inverting control signal VGHO may have the low level and the second inverting control signal VGHE may have the high level in an (N+1)-th frame.

However, the invention may not be limited to a case in which the first inverting control signal VGHO and the second inverting control signal VGHE alternate in the unit of the frame.

When the three buffer circuits share the CQ node, the gate driver 300 may further include a third buffer circuit that outputs a third clock signal CLK3 as a third gate output signal GW3[N] in response to a signal of a Q3 node and a third pull down holding circuit that holds a low level of the third gate output signal GW3[N] in response to the signal of the QB1 node.

The third buffer circuit may include a 10-3 transistor T10-3 including a control electrode connected to the Q3 node, a first electrode that receives the third clock signal CLK3 and a second electrode connected to a third gate output terminal.

The third pull down holding circuit may include an 11-3 transistor T11-3 including a control electrode connected to the QB1 node, a first electrode that receives the first low power voltage VGL1 and a second electrode connected to the third gate output terminal.

The gate driver 300 may further include a 3-2 pull down holding circuit that holds the low level of the third gate output signal GW3[N] in response to the signal of the QB2 node.

The 3-2 pull down holding circuit may include an 12-3 transistor T12-3 including a control electrode connected to the QB2 node, a first electrode that receives the first low power voltage VGL1 and a second electrode connected to the third gate output terminal.

The gate driver 300 may further include a third node separating circuit connected to the third gate output terminal and the CQ node.

The third node separating circuit may include a 22-3 transistor T22-3 including a control electrode that receives the node separating control signal GI[N], a first electrode connected to the CQ node and a second electrode connected to the Q3 node. A bootstrap voltage of the Q3 node may not be transmitted to the CQ node by the third node separating circuit so that the 10-3 transistor T10-3 may output the third gate output signal GW3[N] more stably. In addition, a horizontal line defect which may occur, when the bootstrap voltage of the Q3 node is transmitted to the CQ node, may be effectively prevented.

The gate driver 300 may further include a first capacitor C1 including a first electrode connected to the CRQ node and a second electrode connected to the carry output terminal, a second capacitor C2 including a first electrode connected to the first inverting control node NI1 and a second electrode connected to the QB1 node, a third capacitor C3 including a first electrode connected to the second inverting control node NI2 and a second electrode connected to the QB2 node, a 4-1 capacitor C4-1 including a first electrode connected to the Q1 node and a second electrode connected to first gate output terminal, a 4-2 capacitor C4-2 including a first electrode connected to the Q2 node and a second electrode connected to second gate output terminal and a 4-3 capacitor C4-3 including a first electrode connected to the Q3 node and a second electrode connected to third gate output terminal.

The first capacitor C1 may be included in the carry buffer circuit. When the carry signal CR[N] is outputted, the first capacitor C1 may bootstrap the signal of the CRQ node.

The second capacitor C2 may be included in the inverting circuit. The third capacitor C3 may be included in the second inverting circuit.

The 4-1 capacitor C4-1 may be included in the first buffer circuit. When the first gate output signal GW1[N] is outputted, the 4-1 capacitor C4-1 may bootstrap the signal of the Q1 node.

The 4-2 capacitor C4-2 may be included in the second buffer circuit. When the second gate output signal GW2[N] is outputted, the 4-2 capacitor C4-2 may bootstrap the signal of the Q2 node.

The 4-3 capacitor C4-3 may be included in the third buffer circuit. When the third gate output signal GW3[N] is outputted, the 4-3 capacitor C4-3 may bootstrap the signal of the Q3 node.

In an embodiment, for example, the 2-1 transistor T2-1 may further include a second control electrode connected to the control electrode of the 2-1 transistor T2-1. In an embodiment, for example, the 2-2 transistor T2-2 may further include a second control electrode connected to the control electrode of the 2-2 transistor T2-2.

In an embodiment, for example, the 3-1 transistor T3-1 may further include a second control electrode connected to the control electrode of the 3-1 transistor T3-1. In an embodiment, for example, the 3-2 transistor T3-2 may further include a second control electrode connected to the control electrode of the 3-2 transistor T3-2.

In an embodiment, for example, the 4-1 transistor T4-1 may further include a second control electrode connected to the control electrode of the 4-1 transistor T4-1. In an embodiment, for example, the 4-2 transistor T4-2 may further include a second control electrode connected to the control electrode of the 4-2 transistor T4-2.

In an embodiment, for example, the eighth transistor T8 may further include a second control electrode connected to the first electrode of the eighth transistor T8. In an embodiment, for example, the ninth transistor T9 may further include a second control electrode connected to the first electrode of the ninth transistor T9.

In an embodiment, for example, the 10-1 transistor T10-1 may further include a second control electrode connected to the control electrode of the 10-1 transistor T10-1. In an embodiment, for example, the 10-2 transistor T10-2 may further include a second control electrode connected to the control electrode of the 10-2 transistor T10-2. In an embodiment, for example, the 10-3 transistor T10-3 may further include a second control electrode connected to the control electrode of the 10-3 transistor T10-3.

In an embodiment, for example, the 11-1 transistor T11-1 may further include a second control electrode connected to the control electrode of the 11-1 transistor T11-1. In an embodiment, for example, the 11-2 transistor T11-2 may further include a second control electrode connected to the control electrode of the 11-2 transistor T11-2. In an embodiment, for example, the 11-3 transistor T11-3 may further include a second control electrode connected to the control electrode of the 11-3 transistor T11-3.

In an embodiment, for example, the 12-1 transistor T12-1 may further include a second control electrode connected to the control electrode of the 12-1 transistor T12-1. In an embodiment, for example, the 12-2 transistor T12-2 may further include a second control electrode connected to the control electrode of the 12-2 transistor T12-2. In an embodiment, for example, the 12-3 transistor T12-3 may further include a second control electrode connected to the control electrode of the 12-3 transistor T12-3.

In an embodiment, for example, the 13-1 transistor T13-1 may further include a second control electrode connected to the control electrode of the 13-1 transistor T13-1. In an embodiment, for example, the 13-2 transistor T13-2 may further include a second control electrode connected to the control electrode of the 13-2 transistor T13-2. In an embodiment, for example, the fourteenth transistor T14 may further include a second control electrode connected to the control electrode of the fourteenth transistor T14. In an embodiment, for example, the fifteenth transistor T15 may further include a second control electrode connected to the control electrode of the fifteenth transistor T15. In an embodiment, for example, the sixteenth transistor T16 may further include a second control electrode connected to the control electrode of the sixteenth transistor T16.

In an embodiment, for example, the 17-1 transistor T17-1 may further include a second control electrode connected to the control electrode of the 17-1 transistor T17-1. In an embodiment, for example, the 17-2 transistor T17-2 may further include a second control electrode connected to the control electrode of the 17-2 transistor T17-2. In an embodiment, for example, the eighteenth transistor T18 may further include a second control electrode connected to the control electrode of the eighteenth transistor T18. In an embodiment, for example, the nineteenth transistor T19 may further include a second control electrode connected to the control electrode of the nineteenth transistor T19. In an embodiment, for example, the twentieth transistor T20 may further include a second control electrode connected to the control electrode of the twentieth transistor T20. Here, a second control electrode of a transistor means an additional control electrode further included in addition to a control electrode the transistor.

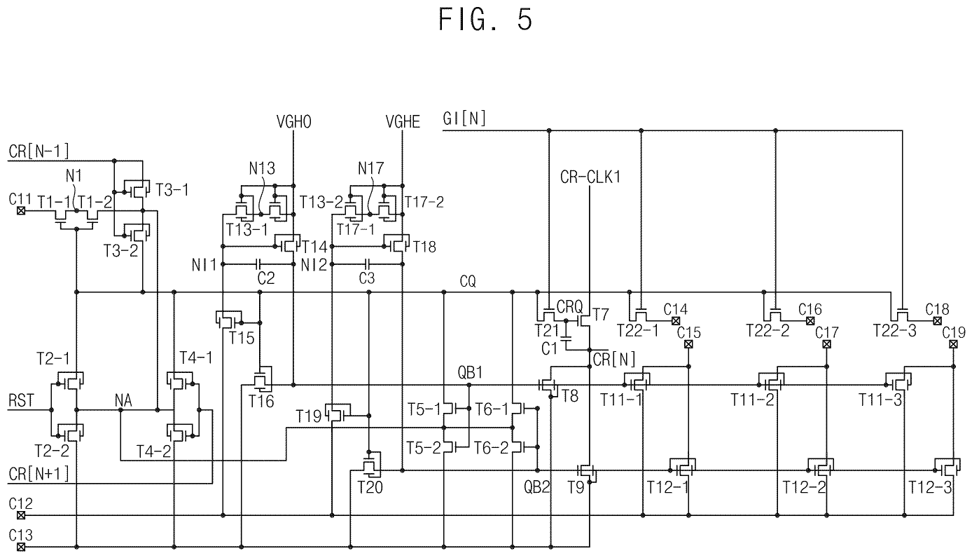

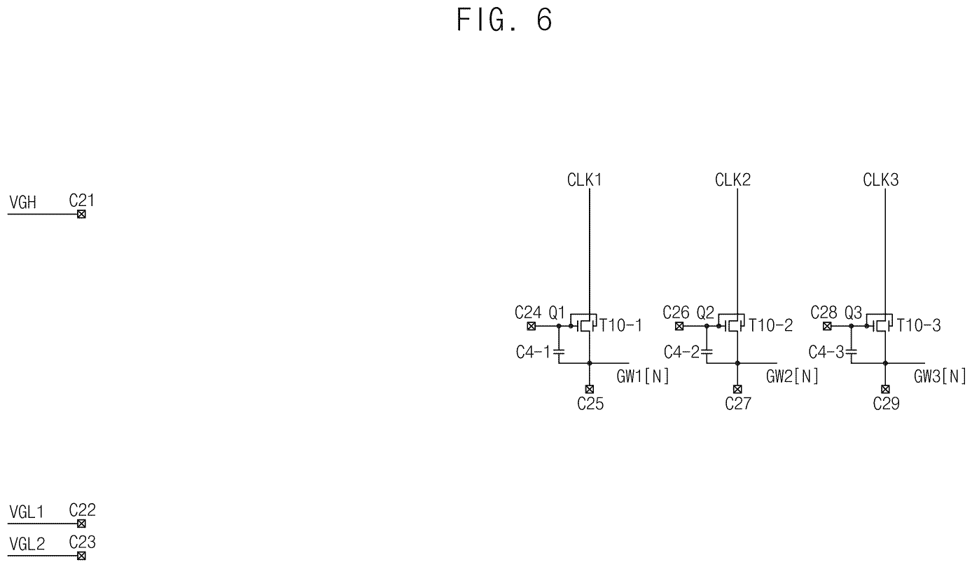

FIG. 5 is a circuit diagram illustrating a first circuit of the gate driver 300 of FIG. 3 disposed in the first layer. FIG. 6 is a circuit diagram illustrating a second circuit of the gate driver 300 of FIG. 3 disposed in the second layer.

Referring to FIGS. 1 to 6, in an embodiment, the 1-1 transistor T1-1, the 1-2 transistor T1-2, the 2-1 transistor T2-1, the 2-2 transistor T2-2, the 3-1 transistor T3-1, the 3-2 transistor T3-2, the 4-1 transistor T4-1, the 4-2 transistor T4-2, the 5-1 transistor T5-1, the 5-2 transistor T5-2, the 6-1 transistor T6-1, the 6-2 transistor T6-2, the seventh transistor T7, the eighth transistor T8, the ninth transistor T9, the 11-1 transistor T11-1, the 11-2 transistor T11-2, the 12-1 transistor T12-1, the 12-2 transistor T12-2, the 13-1 transistor T13-1, the 13-2 transistor T13-2, the fourteenth transistor T14, the fifteenth transistor T15, the sixteenth transistor T16, the 17-1 transistor T17-1, the 17-2 transistor T17-2, the eighteenth transistor T18, the nineteenth transistor T19, the twentieth transistor T20, the twenty first transistor T21, the 22-1 transistor T22-1, the 22-2 transistor T22-2, the first capacitor C1, the second capacitor C2 and the third capacitor C3 may be disposed in the first layer. The 10-1 transistor T10-1, the 10-2 transistor T10-2, the 4-1 capacitor C4-1 and the 4-2 capacitor C4-2 may be disposed in the second layer.

In such an embodiment, the 11-3 transistor T11-3 and the 12-3 transistor T12-3 may be disposed in the first layer. The 10-3 transistor T10-3 and the 4-3 capacitor C4-3 may be disposed in the second layer.

In such an embodiment, power lines of the high power voltage VGH, the first low power voltage VGL1 and the second low power voltage VGL2 may be disposed in the second layer.

In an embodiment, for example, the high power voltage VGH may be applied from the second layer to the first layer through a 1-1 contact hole C11 and a 2-1 contact hole C21. In an embodiment, for example, the first low power voltage VGL1 may be applied from the second layer to the first layer through a 1-2 contact hole C12 and a 2-2 contact hole C22. In an embodiment, for example, the second low power voltage VGL2 may be applied from the second layer to the first layer through a 1-3 contact hole C13 and a 2-3 contact hole C23. Here, a 1-n contact hole (n is a natural number) may be a contact hole defined in the first layer, and a 2-m contact hole (m is a natural number) may be a contact hole defined in the second layer.

In an embodiment, for example, the Q1 node in the first layer may be connected to the Q1 node in the second layer through a 1-4 contact hole C14 and a 2-4 contact hole C24. In an embodiment, for example, the first gate output terminal in the first layer may be connected to the first gate output terminal in the second layer through a 1-5 contact hole C15 and a 2-5 contact hole C25.

In an embodiment, for example, the Q2 node in the first layer may be connected to the Q2 node in the second layer through a 1-6 contact hole C16 and a 2-6 contact hole C26. In an embodiment, for example, the second gate output terminal in the first layer may be connected to the second gate output terminal in the second layer through a 1-7 contact hole C17 and a 2-7 contact hole C27.

In an embodiment, for example, the Q3 node in the first layer may be connected to the Q3 node in the second layer through a 1-8 contact hole C18 and a 2-8 contact hole C28. In an embodiment, for example, the third gate output terminal in the first layer may be connected to the third gate output terminal in the second layer through a 1-9 contact hole C19 and a 2-9 contact hole C29.

According to an embodiment, all of the transistors included in the gate driver 300 may be N-type transistors.

In such an embodiment where all of the transistors of the display panel 100 are N-type transistors to prevent a current leakage and the gate driver 300 is integrated on the display panel 100, all of the transistors included in the gate driver 300 may be N-type transistors. Accordingly, the manufacturing process may be simplified and the current leakage in the gate driver 300 may be substantially reduced or effectively prevented. The flicker due to the current leakage may be substantially reduced or effectively prevented so that the display quality of the display panel 100 may be enhanced.

In an embodiment, the first circuit of the gate driver 300 may be disposed in the first layer and the second circuit of the gate driver 300 may be disposed in the second layer overlapping the first layer so that the dead space of the display apparatus may be reduced.

In an embodiment, the plurality of the buffer circuits T10-1, T10-2 and T10-3 of the gate driver 300 may share a single pull up control node (the CQ node) of the gate driver 300 so that the dead space of the display apparatus may be further reduced.

In addition, the common Q node (the CQ node) may be precharged or discharged not based on the clock signal but based on the previous carry signal CR[N−1] and the next carry signal CR[N+1] so that the power consumption of the gate driver 300 may be reduced and the ripple due to the clock signal may be effectively prevented.

In addition, the inverting circuit, the pull down holding circuit, the carry pull down holding circuit and the QB node may be formed in a dual configuration so that the deteriorations of the inverting circuit, the pull down holding circuit, the carry pull down holding circuit and the QB node may be effectively prevented.

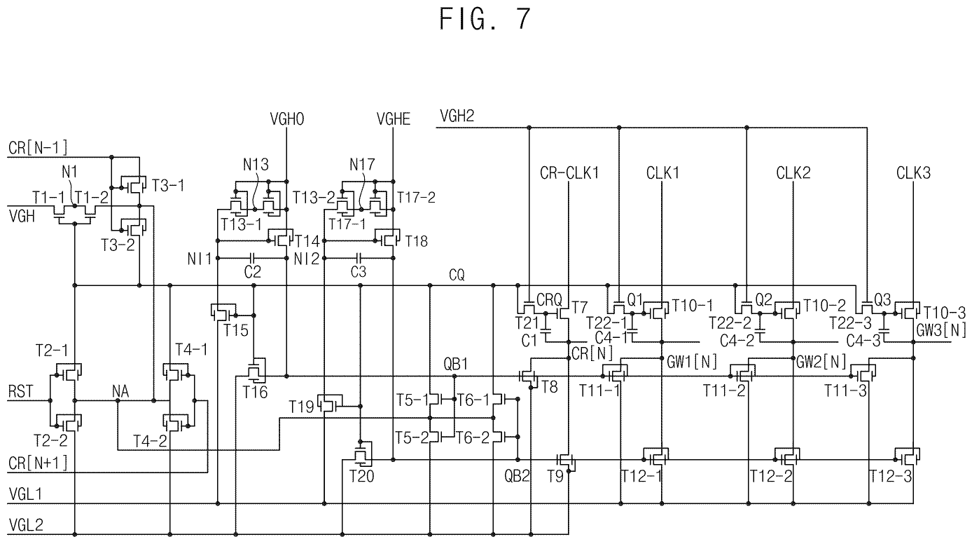

FIG. 7 is a circuit diagram illustrating a gate driver 300 of a display apparatus according to an embodiment of the invention.

The gate driver 300 according to the embodiment illustrated in FIG. 7 is substantially the same as the gate driver 300 of the embodiment illustrated in FIG. 3 except for the node separating control signal. Thus, the same reference numerals will be used to refer to the same or like parts as those described above with reference to FIGS. 1 to 6 and any repetitive detailed description thereof will be omitted or simplified.

Referring to FIGS. 1, 2 and 4 to 7, an embodiment of the gate driver 300 includes an input circuit that transmits a previous carry signal CR[N−1] to a CQ node in response to the previous carry signal CR[N−1], a first buffer circuit that outputs a first clock signal CLK1 as a first gate output signal GW1[N] in response to a signal of a Q1 node, a second buffer circuit that outputs a second clock signal CLK2 as a second gate output signal GW2[N] in response to a signal of a Q2 node, a first pull down holding circuit that holds a low level of the first gate output signal GW1[N] in response to a signal of a QB1 node and a second pull down holding circuit that holds a low level of the second gate output signal GW2[N] in response to the signal of the QB1 node.

In such an embodiment, the gate driver 300 may further include a first node separating circuit connected to the first gate output terminal and the CQ node and a second node separating circuit connected to the second gate output terminal and the CQ node.

In such an embodiment, a control signal of the first node separating circuit may be a second high power voltage VGH2. A control signal of the second node separating circuit may be the second high power voltage VGH2.

In an embodiment, for example, the second high power voltage VGH2 may be less than the high power voltage VGH. The second high power voltage VGH2 may be greater than the first low power voltage VGL1 and the second low power voltage VGL2. That is, the voltage level of the second high power voltage VGH2 may be higher than the voltage level of the first low power voltage VGL1 and the voltage level of the second low power voltage VGL2

The first node separating circuit may include a 22-1 transistor T22-1 including a control electrode that receives a node separating control signal VGH2, a first electrode connected to the CQ node and a second electrode connected to the Q1 node. A bootstrap voltage of the Q1 node may not be transmitted to the CQ node by the first node separating circuit so that the 10-1 transistor T10-1 may output the first gate output signal GW1[N] more stably. In addition, a horizontal line defect, which may occur when the bootstrap voltage of the Q1 node is transmitted to the CQ node, may be effectively prevented.

The second node separating circuit may include a 22-2 transistor T22-2 including a control electrode that receives the node separating control signal VGH2, a first electrode connected to the CQ node and a second electrode connected to the Q2 node. A bootstrap voltage of the Q2 node may not be transmitted to the CQ node by the second node separating circuit so that the 10-2 transistor T10-2 may output the second gate output signal GW2[N] more stably. In addition, a horizontal line defect, which may occur when the bootstrap voltage of the Q2 node is transmitted to the CQ node, may be effectively prevented.

The gate driver 300 may further include a carry node separating circuit connected to a carry output terminal and the CQ node.

The carry node separating circuit may include a twenty first transistor T21 including a control electrode that receives the node separating control signal VGH2, a first electrode connected to the CQ node and a second electrode connected to the CRQ node. A bootstrap voltage of the CRQ node may not be transmitted to the CQ node by the carry node separating circuit so that the seventh transistor T7 may output the carry signal CR[N] more stably. In addition, a horizontal line defect, which may occur when the bootstrap voltage of the CRQ node is transmitted to the CQ node, may be effectively prevented.

The gate driver 300 may further include a third node separating circuit connected to the third gate output terminal and the CQ node.

The third node separating circuit may include a 22-3 transistor T22-3 including a control electrode that receives the node separating control signal VGH2, a first electrode connected to the CQ node and a second electrode connected to the Q3 node. A bootstrap voltage of the Q3 node may not be transmitted to the CQ node by the third node separating circuit so that the 10-3 transistor T10-3 may output the third gate output signal GW3[N] more stably. In addition, a horizontal line defect, which may occur when the bootstrap voltage of the Q3 node is transmitted to the CQ node, may be effectively prevented.

According to an embodiment, all of the transistors included in the gate driver 300 may be N-type transistors.

In such an embodiment where all of the transistors of the display panel 100 are N-type transistors to prevent a current leakage and the gate driver 300 is integrated on the display panel 100, all of the transistors included in the gate driver 300 may be N-type transistors. Accordingly, the manufacturing process may be simplified and the current leakage in the gate driver 300 may be substantially reduced or effectively prevented. The flicker due to the current leakage may be substantially reduced or effectively prevented so that the display quality of the display panel 100 may be enhanced.

In an embodiment, the first circuit of the gate driver 300 may be disposed in the first layer and the second circuit of the gate driver 300 may be disposed in the second layer overlapping the first layer so that the dead space of the display apparatus may be reduced.

In an embodiment, the plurality of the buffer circuits T10-1, T10-2 and T10-3 of the gate driver 300 may share a single pull up control node (the CQ node) of the gate driver 300 so that the dead space of the display apparatus may be further reduced.

In addition, the common Q node (the CQ node) may be precharged or discharged not based on the clock signal but based on the previous carry signal CR[N−1] and the next carry signal CR[N+1] so that the power consumption of the gate driver 300 may be reduced and the ripple due to the clock signal may be effectively prevented.

In addition, the inverting circuit, the pull down holding circuit, the carry pull down holding circuit and the QB node may be formed in a dual configuration so that the deteriorations of the inverting circuit, the pull down holding circuit, the carry pull down holding circuit and the QB node may be effectively prevented.

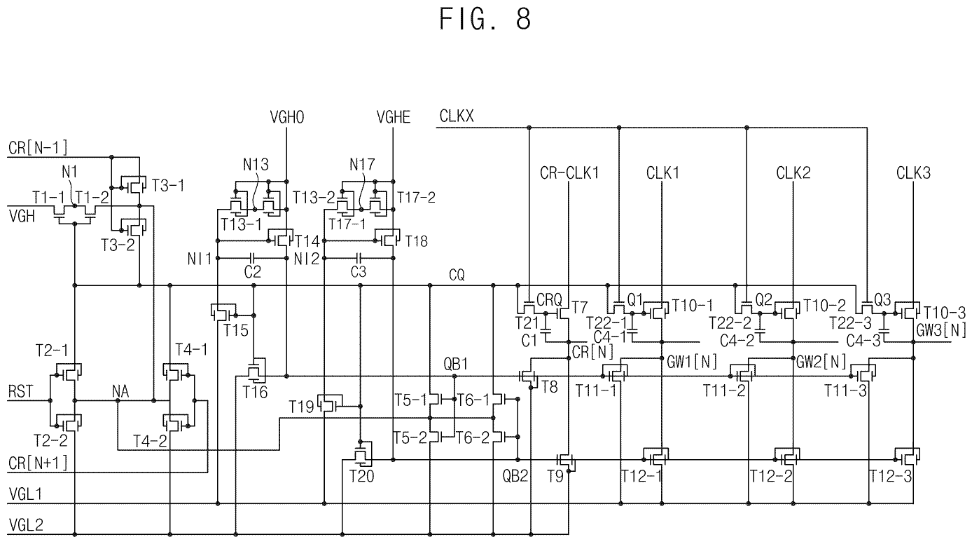

FIG. 8 is a circuit diagram illustrating a gate driver 300 of a display apparatus according to an embodiment of the invention.

The gate driver 300 according to the embodiment illustrated in FIG. 8 is substantially the same as the gate driver 300 of the embodiment illustrated in FIG. 3 except for the node separating control signal. Thus, the same reference numerals will be used to refer to the same or like parts as those described above with reference to FIGS. 1 to 6 and any repetitive detailed description thereof will be omitted or simplified.

Referring to FIGS. 1, 2, 4 to 6 and 8, an embodiment of the gate driver 300 includes an input circuit that transmits a previous carry signal CR[N−1] to a CQ node in response to the previous carry signal CR[N−1], a first buffer circuit that outputs a first clock signal CLK1 as a first gate output signal GW1[N] in response to a signal of a Q1 node, a second buffer circuit that outputs a second clock signal CLK2 as a second gate output signal GW2[N] in response to a signal of a Q2 node, a first pull down holding circuit that holds a low level of the first gate output signal GW1[N] in response to a signal of a QB1 node and a second pull down holding circuit that holds a low level of the second gate output signal GW2[N] in response to the signal of the QB1 node.

In such an embodiment, the gate driver 300 may further include a first node separating circuit connected to the first gate output terminal and the CQ node and a second node separating circuit connected to the second gate output terminal and the CQ node.

In such an embodiment, a control signal of the first node separating circuit may be a clock signal CLKX different from the first clock signal CLK1 and the second clock signal CLK2. A control signal of the second node separating circuit may be the clock signal CLKX. A high period of the clock signal CLKX may overlap a high period of the first gate output circuit GW1[N] and a high period of the second gate output circuit GW2[N].

A signal having a high level at an output timing of the first gate output signal GW1[N] and an output timing of the first gate output signal GW2[N] may be used as a node separating control signal (e.g., CLKX) which is a control signal of the first node separating circuit and the second node separating circuit. In such an embodiment, one (e.g., CLKX) of clock signals in the display apparatus is used as the node separating control signal so that a structure for generating the node separating control signal may be omitted and a separate power voltage may not need to be generated, and accordingly, a circuit of the display apparatus may be simplified.

The first node separating circuit may include a 22-1 transistor T22-1 including a control electrode that receives a node separating control signal CLKX, a first electrode connected to the CQ node and a second electrode connected to the Q1 node. A bootstrap voltage of the Q1 node may not be transmitted to the CQ node by the first node separating circuit so that the 10-1 transistor T10-1 may output the first gate output signal GW1[N] more stably. In addition, a horizontal line defect, which may occur when the bootstrap voltage of the Q1 node is transmitted to the CQ node, may be effectively prevented.

The second node separating circuit may include a 22-2 transistor T22-2 including a control electrode that receives the node separating control signal CLKX, a first electrode connected to the CQ node and a second electrode connected to the Q2 node. A bootstrap voltage of the Q2 node may not be transmitted to the CQ node by the second node separating circuit so that the 10-2 transistor T10-2 may output the second gate output signal GW2[N] more stably. In addition, a horizontal line defect, which may occur when the bootstrap voltage of the Q2 node is transmitted to the CQ node, may be effectively prevented.

The gate driver 300 may further include a carry node separating circuit connected to a carry output terminal and the CQ node.

The carry node separating circuit may include a twenty first transistor T21 including a control electrode that receives the node separating control signal CLKX, a first electrode connected to the CQ node and a second electrode connected to the CRQ node. A bootstrap voltage of the CRQ node may not be transmitted to the CQ node by the carry node separating circuit so that the seventh transistor T7 may output the carry signal CR[N] more stably. In addition, a horizontal line defect, which may occur when the bootstrap voltage of the CRQ node is transmitted to the CQ node, may be effectively prevented.

The gate driver 300 may further include a third node separating circuit connected to the third gate output terminal and the CQ node.

The third node separating circuit may include a 22-3 transistor T22-3 including a control electrode that receives the node separating control signal CLKX, a first electrode connected to the CQ node and a second electrode connected to the Q3 node. A bootstrap voltage of the Q3 node may not be transmitted to the CQ node by the third node separating circuit so that the 10-3 transistor T10-3 may output the third gate output signal GW3[N] more stably. In addition, a horizontal line defect, which may occur when the bootstrap voltage of the Q3 node is transmitted to the CQ node, may be effectively prevented.

According to an embodiment, all of the transistors included in the gate driver 300 may be N-type transistors.

In such an embodiment where all of the transistors of the display panel 100 are N-type transistors to prevent a current leakage and the gate driver 300 is integrated on the display panel 100, all of the transistors included in the gate driver 300 may be N-type transistors. Accordingly, the manufacturing process may be simplified and the current leakage in the gate driver 300 may be substantially reduced or effectively prevented. The flicker due to the current leakage may be substantially reduced or effectively prevented so that the display quality of the display panel 100 may be enhanced.

In an embodiment, the first circuit of the gate driver 300 may be disposed in the first layer and the second circuit of the gate driver 300 may be disposed in the second layer overlapping the first layer so that the dead space of the display apparatus may be reduced.

In an embodiment, the plurality of the buffer circuits T10-1, T10-2 and T10-3 of the gate driver 300 may share a single pull up control node (the CQ node) of the gate driver 300 so that the dead space of the display apparatus may be further reduced.

In addition, the common Q node (the CQ node) may be precharged or discharged not based on the clock signal but based on the previous carry signal CR[N−1] and the next carry signal CR[N+1] so that the power consumption of the gate driver 300 may be reduced and the ripple due to the clock signal may be effectively prevented.

In addition, the inverting circuit, the pull down holding circuit, the carry pull down holding circuit and the QB node may be formed in a dual configuration so that the deteriorations of the inverting circuit, the pull down holding circuit, the carry pull down holding circuit and the QB node may be effectively prevented.

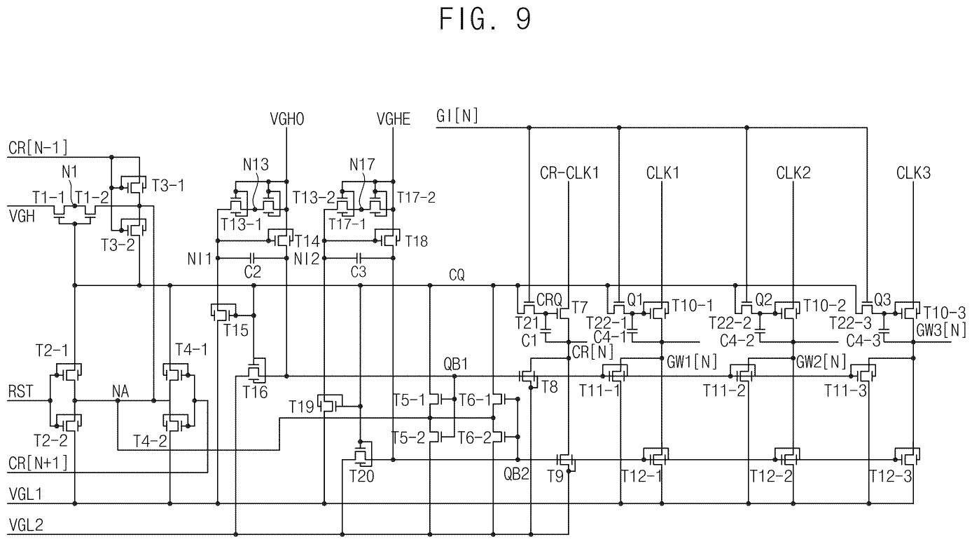

FIG. 9 is a circuit diagram illustrating a gate driver 300 of a display apparatus according to an embodiment of the invention.

The gate driver 300 according to the embodiment illustrated in FIG. 9 is substantially the same as the gate driver 300 of the embodiment illustrated in FIG. 3 except for a structure of a reset circuit and a structure of a first CQ node control circuit. Thus, the same reference numerals will be used to refer to the same or like parts as those described above with reference to FIGS. 1 to 6 and any repetitive detailed description thereof will be omitted or simplified.

Referring to FIGS. 1, 2, 4 to 6 and 9, an embodiment of the gate driver 300 includes an input circuit that transmits a previous carry signal CR[N−1] to a CQ node in response to the previous carry signal CR[N−1], a first buffer circuit that outputs a first clock signal CLK1 as a first gate output signal GW1[N] in response to a signal of a Q1 node, a second buffer circuit that outputs a second clock signal CLK2 as a second gate output signal GW2[N] in response to a signal of a Q2 node, a first pull down holding circuit that holds a low level of the first gate output signal GW1[N] in response to a signal of a QB1 node and a second pull down holding circuit that holds a low level of the second gate output signal GW2[N] in response to the signal of the QB1 node.

In such an embodiment, the gate driver 300 may further include a first CQ node control circuit that applies a first low power voltage VGL1 or a second low power voltage VGL2 to the CQ node in response to a next carry signal CR[N+1]. The first CQ node control circuit may discharge the CQ node in response to the next carry signal CR[N+1].

In such an embodiment, the first CQ node control circuit may apply the first low power voltage VGL1 to the CQ node in response to the next carry signal CR[N+1].

The first CQ node control circuit may include a 4-1 transistor T4-1 including a control electrode that receives the next carry signal CR[N+1], a first electrode connected to the CQ node and a second electrode connected to a fourth intermediate node NA and a 4-2 transistor T4-2 including a control electrode that receives the next carry signal CR[N+1], a first electrode that receives the first low power voltage VGL1 and a second electrode connected to the fourth intermediate node NA.

The gate driver 300 may further include a reset circuit that applies the first low power voltage VGL1 or the second low power voltage VGL2 to the CQ node in response to a reset signal RST.

In such an embodiment, the reset circuit may apply the first low power voltage VGL1 to the CQ node in response to the reset signal RST.

The reset signal RST may have an active level in an initial turn-on period when the display apparatus is started to be turned on. The display panel 100 may not unintentionally emit a light in the initial turn-on period by the reset signal RST.

The reset circuit may include a 2-1 transistor T2-1 including a control electrode that receives the reset signal RST, a first electrode connected to the CQ node and a second electrode connected to a second intermediate node NA and a 2-2 transistor T2-2 including a control electrode that receives the reset signal RST, a first electrode that receives the first low power voltage VGL1 and a second electrode connected to the second intermediate node NA.

According to an embodiment, all of the transistors included in the gate driver 300 may be N-type transistors.

In such an embodiment where all of the transistors of the display panel 100 are N-type transistors to prevent a current leakage and the gate driver 300 is integrated on the display panel 100, all of the transistors included in the gate driver 300 may be N-type transistors. Accordingly, the manufacturing process may be simplified and the current leakage in the gate driver 300 may be substantially reduced or effectively prevented. The flicker due to the current leakage may be substantially reduced or effectively prevented so that the display quality of the display panel 100 may be enhanced.

In an embodiment, the first circuit of the gate driver 300 may be disposed in the first layer and the second circuit of the gate driver 300 may be disposed in the second layer overlapping the first layer so that the dead space of the display apparatus may be reduced.

In an embodiment, the plurality of the buffer circuits T10-1, T10-2 and T10-3 of the gate driver 300 may share a single pull up control node (the CQ node) of the gate driver 300 so that the dead space of the display apparatus may be further reduced.

In addition, the common Q node (the CQ node) may be precharged or discharged not based on the clock signal but based on the previous carry signal CR[N−1] and the next carry signal CR[N+1] so that the power consumption of the gate driver 300 may be reduced and the ripple due to the clock signal may be effectively prevented.

In addition, the inverting circuit, the pull down holding circuit, the carry pull down holding circuit and the QB node may be formed in a dual configuration so that the deteriorations of the inverting circuit, the pull down holding circuit, the carry pull down holding circuit and the QB node may be effectively prevented.

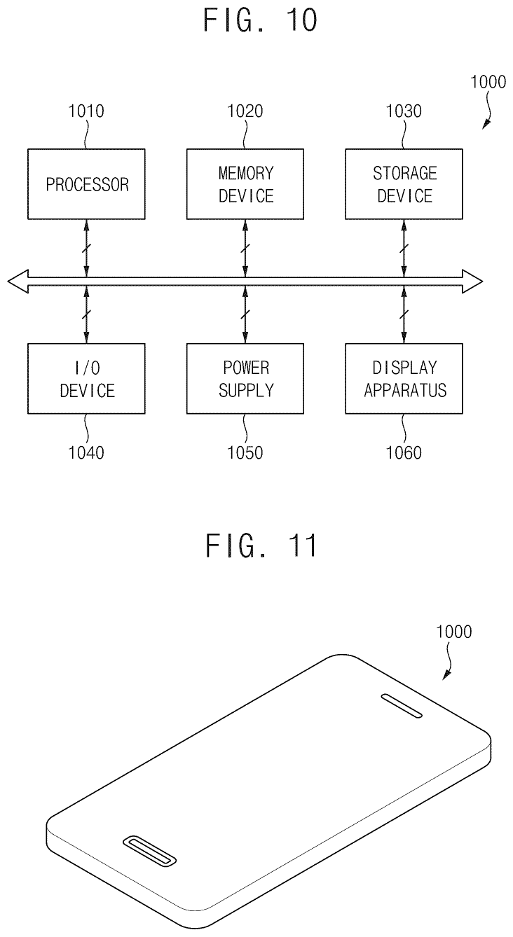

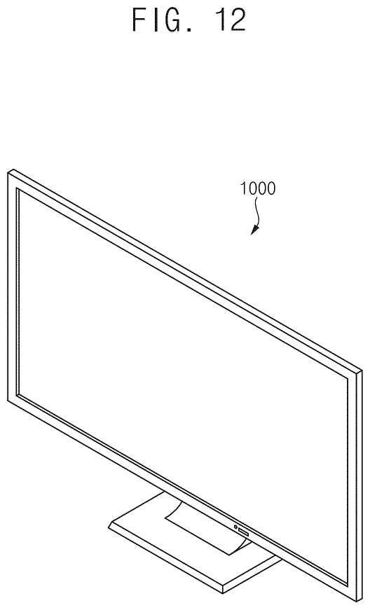

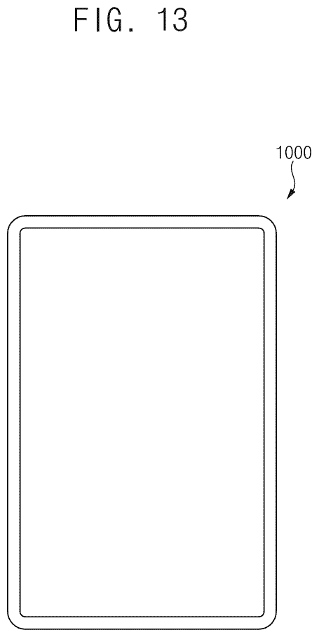

FIG. 10 is a block diagram illustrating an electronic apparatus 1000 according to an embodiment of the invention. FIG. 11 is a diagram illustrating an example in which the electronic apparatus 1000 of FIG. 10 is implemented as a smart phone. FIG. 12 is a diagram illustrating an example in which the electronic apparatus 1000 of FIG. 10 is implemented as a monitor. FIG. 13 is a diagram illustrating an example in which the electronic apparatus 1000 of FIG. 10 is implemented as a tablet PC.

Referring to FIGS. 10 to 13, an embodiment of the electronic apparatus 1000 may include a processor 1010, a memory device 1020, a storage device 1030, an input/output (I/O) device 1040, a power supply 1050, and a display apparatus 1060. Here, the display apparatus 1060 may be the display apparatus of FIG. 1. In addition, the electronic apparatus 1000 may further include a plurality of ports for communicating with a video card, a sound card, a memory card, a universal serial bus (USB) device, other electronic apparatuses, etc.

In an embodiment, as illustrated in FIG. 11, the electronic apparatus 1000 may be implemented as a smart phone. In an embodiment, as illustrated in FIG. 12, the electronic apparatus 1000 may be implemented as a monitor. In an embodiment, as illustrated in FIG. 13, the electronic apparatus 1000 may be implemented as a tablet personal computer (PC). However, the electronic apparatus 1000 is not limited thereto. In another embodiment, for example, the electronic apparatus 1000 may be implemented as a cellular phone, a video phone, a smart pad, a smart watch, a car navigation system, a laptop computer, a head mounted display (HMD) device, or the like.

The processor 1010 may perform various computing functions or various tasks. The processor 1010 may be a micro-processor, a central processing unit (CPU), an application processor (AP), or the like. The processor 1010 may be coupled to other components via an address bus, a control bus, a data bus, etc. Further, the processor 1010 may be coupled to an extended bus such as a peripheral component interconnection (PCI) bus.

The processor 1010 may output the input image data IMG and the input control signal CONT to the driving controller 200 of FIG. 1.

The memory device 1020 may store data for operations of the electronic apparatus 1000. In an embodiment, for example, the memory device 1020 may include at least one non-volatile memory device such as an erasable programmable read-only memory (EPROM) device, an electrically erasable programmable read-only memory (EEPROM) device, a flash memory device, a phase change random access memory (PRAM) device, a resistance random access memory (RRAM) device, a nano floating gate memory (NFGM) device, a polymer random access memory (PoRAM) device, a magnetic random access memory (MRAM) device, a ferroelectric random access memory (FRAM) device, or the like and/or at least one volatile memory device such as a dynamic random access memory (DRAM) device, a static random access memory (SRAM) device, a mobile DRAM device, or the like.

The storage device 1030 may include a solid state drive (SSD) device, a hard disk drive (HDD) device, a CD-ROM device, or the like. The I/O device 1040 may include an input device such as a keyboard, a keypad, a mouse device, a touch-pad, a touch-screen, and the like and an output device such as a printer, a speaker, or the like. In some embodiments, the display apparatus 1060 may be included in the I/O device 1040. The power supply 1050 may provide power for operations of the electronic apparatus 1000. The display apparatus 1060 may be coupled to other components via the buses or other communication links. The gate driver 300 5 in FIGS. 2, 3, 7, 8 and 9 may be included in the display apparatus 1060.

According to the display apparatus of the invention as explained above, the dead space of the display apparatus may be reduced.

The invention should not be construed as being limited to the embodiments set forth herein. Rather, these embodiments are provided so that this disclosure will be thorough and complete and will fully convey the concept of the invention to those skilled in the art.

While the invention has been particularly shown and described with reference to embodiments thereof, it will be understood by those of ordinary skill in the art that various changes in form and details may be made therein without departing from the spirit or scope of the invention as defined by the following claims.

What is claimed is:

1. An electronic apparatus comprising:
a gate driver;
a driving controller which controls the gate driver; and
a processor which outputs input image data and an input control signal to the driving controller,
wherein the gate driver comprises:
an input circuit which transmits a previous carry signal to a CQ node in response to the previous carry signal;
a first buffer circuit which outputs a first clock signal as a first gate output signal in response to a signal of a Q1 node;
a second buffer circuit which outputs a second clock signal as a second gate output signal in response to a signal of a Q2 node;
a first pull down holding circuit which holds a low level of the first gate output signal in response to a signal of a QB1 node; and
a second pull down holding circuit which holds a low level of the second gate output signal in response to the signal of the QB1 node,
wherein the input circuit is disposed in a first layer, and
wherein the first buffer layer and the second buffer layer are disposed in a second layer overlapping the first layer.

2. The electronic apparatus of claim 1, wherein the gate driver further comprises a first CQ node control circuit which applies a first low power voltage or a second low power voltage to the CQ node in response to a next carry signal.

3. The electronic apparatus of claim 1, wherein the gate driver further comprises a second CQ node control circuit which applies a second low power voltage to the CQ node in response to the signal of the QB1 node.

4. The electronic apparatus of claim 1, wherein the gate driver further comprises an inverting circuit which controls the signal of the QB1 node in response to a first inverting control signal and a signal of the CQ node.

5. The electronic apparatus of claim 1, wherein the gate driver further comprises a carry buffer circuit which outputs a first carry clock signal as a carry signal in response to a signal of a CRQ node.

6. The electronic apparatus of claim 5, wherein the gate driver further comprises a carry pull down holding circuit which holds a low level of the carry signal in response to the signal of the QB1 node.

7. The electronic apparatus of claim 5, wherein the gate driver further comprises a carry node separating circuit connected to a carry output terminal and the CQ node.

8. The electronic apparatus of claim 1, wherein the gate driver further comprises:
a first node separating circuit connected to a first gate output terminal and the CQ node; and
a second node separating circuit connected to a second gate output terminal and the CQ node.

9. The electronic apparatus of claim 8, wherein a control signal of the first node separating circuit is an initialization gate signal different from the first gate output signal and the second gate output signal,
wherein a control signal of the second node separating circuit is the initialization gate signal, and
wherein a high period of the initialization gate signal overlaps a high period of the first gate output signal and a high period of the second gate output signal.

10. The electronic apparatus of claim 8, wherein a control signal of the first node separating circuit is a second high power voltage, and
wherein a control signal of the second node separating circuit is the second high power voltage.

11. The electronic apparatus of claim 8, wherein a control signal of the first node separating circuit is a clock signal different from the first clock signal and the second clock signal,
wherein a control signal of the second node separating circuit is the clock signal, and
wherein a high period of the clock signal overlaps a high period of the first gate output signal and a high period of the second gate output signal.

12. The electronic apparatus of claim 1, wherein the gate driver further comprises a reset circuit which applies a first low power voltage or a second low power voltage to the CQ node in response to a reset signal.

13. The electronic apparatus of claim 1, wherein the gate driver further comprises a stabilizing circuit which applies a high power voltage to a third intermediate node connecting a 3-1 transistor and a 3-2 transistor of the input circuit to each other in response to a signal of the CQ node.

14. The electronic apparatus of claim 1, wherein the gate driver further comprises:
a 1-2 pull down holding circuit which holds the low level of the first gate output signal in response to a signal of a QB2 node; and
a 2-2 pull down holding circuit which holds the low level of the second gate output signal in response to the signal of the QB2 node.

15. The electronic apparatus of claim 14, wherein the gate driver further comprises:
a 2-2 CQ node control circuit which applies a second low power voltage to the CQ node in response to the signal of the QB2 node;
a second inverting circuit which controls the signal of the QB2 node in response to a second inverting control circuit and a signal of the CQ node; and
a second carry pull down holding circuit which holds a low level of the carry signal in response to the signal of the QB2 node.

16. The electronic apparatus of claim 1, wherein the gate driver further comprises:
a third buffer circuit which outputs a third clock signal as a third gate output signal in response to a signal of a Q3 node; and
a third pull down holding circuit which holds a low level of the third gate output signal in response to the signal of the QB1 node.

17. The electronic apparatus of claim 1, wherein the input circuit comprises:
a 3-1 transistor including a control electrode which receives the previous carry signal, a first electrode which receives the previous carry signal and a second electrode connected to a third intermediate node; and
a 3-2 transistor including a control electrode which receives the previous carry signal, a first electrode connected to the third intermediate node and a second electrode connected to the CQ node,
wherein the first buffer circuit comprises a 10-1 transistor including a control electrode connected to the Q1 node, a first electrode which receives the first clock signal and a second electrode connected to a first gate output terminal,
wherein the second buffer circuit comprises a 10-2 transistor including a control electrode connected to the Q2 node, a first electrode which receives the second clock signal and a second electrode connected to a second gate output terminal,
wherein the first pull down holding circuit comprises an 11-1 transistor including a control electrode connected to the QB1 node, a first electrode which receives a first low power voltage and a second electrode connected to the first gate output terminal, and
wherein the second pull down holding circuit comprises an 11-2 transistor including a control electrode connected to the QB1 node, a first electrode which receives the first low power voltage and a second electrode connected to the second gate output terminal.

18. The electronic apparatus of claim 17, wherein the gate driver further comprises:
a 1-1 transistor including a control electrode connected to the CQ node, a first electrode which receives a high power voltage and a second electrode connected to a first intermediate node;
a 1-2 transistor including a control electrode connected to the CQ node, a first electrode connected to the first intermediate node and a second electrode connected to the third intermediate node;
a 2-1 transistor including a control electrode which receives a reset signal, a first electrode connected to the CQ node and a second electrode connected to a second intermediate node;
a 2-2 transistor including a control electrode which receives the reset signal, a first electrode which receives a second low power voltage and a second electrode connected to the second intermediate node;
a 4-1 transistor including a control electrode which receives a next carry signal, a first electrode connected to the CQ node and a second electrode connected to a fourth intermediate node;
a 4-2 transistor including a control electrode which receives the next carry signal, a first electrode which receives the second low power voltage and a second electrode connected to the fourth intermediate node;
a 5-1 transistor connected to the QB1 node, a first electrode connected to the CQ node and a second electrode connected to a fifth intermediate node;
a 5-2 transistor including a control electrode connected to the QB1 node, a first electrode which receives the second low power voltage and a second electrode connected to the fifth intermediate node;
a 6-1 transistor including a control electrode connected to a QB2 node, a first electrode connected to the CQ node and a second electrode connected to a sixth intermediate node;
a 6-2 transistor including a control electrode connected to the QB2 node, a first electrode which receives the second low power voltage and a second electrode connected to the sixth intermediate node;
a seventh transistor including a control electrode connected to a CRQ node, a first electrode which receives a first carry clock signal and a second electrode connected to a carry output terminal;
an eighth transistor including a control electrode connected to the QB1 node, a first electrode which receives the second low power voltage and a second electrode connected to the carry output terminal;
a ninth transistor including a control electrode connected to the QB2 node, a first electrode which receives the second low power voltage and a second electrode connected to the carry output terminal;
a 12-1 transistor including a control electrode connected to the QB2 node, a first electrode which receives the first low power voltage and a second electrode connected to the first gate output terminal;
a 12-2 transistor including a control electrode connected to the QB2 node, a first electrode which receives the first low power voltage and a second electrode connected to the second gate output terminal;
a 13-1 transistor including a control electrode which receives a first inverting control signal, a first electrode connected to a first inverting control node and a second electrode connected to a thirteenth intermediate node;
a 13-2 transistor including a control electrode which receives the first inverting control signal, a first electrode which receives the first inverting control signal and a second electrode connected to the thirteenth intermediate node;
a fourteenth transistor including a control electrode connected to the first inverting control node, a first electrode which receives the first inverting control signal and a second electrode connected to the QB1 node;
a fifteenth transistor including a control electrode connected to the CQ node, a first electrode which receives the first low power voltage and a second electrode connected to the first inverting control node;
a sixteenth transistor including a control electrode connected to the CQ node, a first electrode which receives the second low power voltage and a second electrode connected to the QB1 node;
a 17-1 transistor including a control electrode which receives a second inverting control signal, a first electrode connected to a second inverting control node and a second electrode connected to a seventeenth intermediate node;
a 17-2 transistor including a control electrode which receives the second inverting control signal, a first electrode which receives the second inverting control signal and a second electrode connected to the seventeenth intermediate node;
an eighteenth transistor including a control electrode connected to the second inverting control node, a first electrode which receives the second inverting control signal and a second electrode connected to the QB2 node;
a nineteenth transistor including a control electrode connected to the CQ node, a first electrode which receives the first low power voltage and a second electrode connected to the second inverting control node;
a twentieth transistor including a control electrode connected to the CQ node, a first electrode which receives the second low power voltage and a second electrode connected to the QB2 node;
a twenty first transistor including a control electrode which receives a node separating control signal, a first electrode connected to the CQ node and a second electrode connected to the CRQ node;
a 22-1 transistor including a control electrode which receives the node separating control signal, a first electrode connected to the CQ node and a second electrode connected to the Q1 node; and
a 22-2 transistor including a control electrode which receives the node separating control signal, a first electrode connected to the CQ node and a second electrode connected to the Q2 node, and
wherein the second intermediate node, the third intermediate node, the fourth intermediate node, the fifth intermediate node and the sixth intermediate node are connected to one another.

19. The electronic apparatus of claim 18, wherein the gate driver further comprises:
a first capacitor including a first electrode connected to the CRQ node and a second electrode connected to the carry output terminal;
a second capacitor including a first electrode connected to the first inverting control node and a second electrode connected to the QB1 node;
a third capacitor including a first electrode connected to the second inverting control node and a second electrode connected to the QB2 node;
a 4-1 capacitor including a first electrode connected to the Q1 node and a second electrode connected to the first gate output terminal; and
a 4-2 capacitor including a first electrode connected to the Q2 node and a second electrode connected to the second gate output terminal.

20. The electronic apparatus of claim 19, wherein the 1-1 transistor, the 1-2 transistor, the 2-1 transistor, the 2-2 transistor, the 3-1 transistor, the 3-2 transistor, the 4-1 transistor, the 4-2 transistor, the 5-1 transistor, the 5-2 transistor, the 6-1 transistor, the 6-2 transistor, the seventh transistor, the eighth transistor, the ninth transistor, the 11-1 transistor, the 11-2 transistor, the 12-1 transistor, the 12-2 transistor, the 13-1 transistor, the 13-2 transistor, the fourteenth transistor, the fifteenth transistor, the sixteenth transistor, the 17-1 transistor, the 17-2 transistor, the eighteenth transistor, the nineteenth transistor, the twentieth transistor, the twenty first transistor, the 22-1 transistor, the 22-2 transistor, the first capacitor, the second capacitor and the third capacitor are disposed in the first layer, and
wherein the 10-1 transistor, the 10-2 transistor, the 4-1 capacitor and the 4-2 capacitor are disposed in the second layer.
